(19) United States
(12) Patent Application Publication
(10) Pub. No.: US 2020/0307055 A1
(43) Pub. Date: Oct. 1, 2020

(54) INJECTION MOLDING ANALYSIS METHOD AND INJECTION MOLDING ANALYSIS SYSTEM

(71) Applicant: HITACHI, LTD., Tokyo (JP)

(72) Inventors: Ryotaro SHIMADA, Tokyo (JP); Satoshi ARAI, Tokyo (JP); Kei YAMAGUCHI, Tokyo (JP)

(73) Assignee: HITACHI, LTD., Tokyo (JP)

(21) Appl. No.: 16/819,613

(22) Filed: Mar. 16, 2020

(30) Foreign Application Priority Data
Mar. 27, 2019 (JP) 2019-060263

(51) Int. Cl. B29C 45/77; B29C 45/76; B29C 45/26

(52) U.S. Cl. CPC B29C 45/77; B29C 45/26; B29C 45/768; B29C 45/766

(57) ABSTRACT

A method of generating the analysis conditions of an injection molding machine by using at least one computer, the at least one computer executing the steps of: selecting one of injection molding machines, each being associated with a predetermined correction amount of injection molding; generating a second analysis condition for the selected injection molding machine on the basis of an acquired first analysis condition and the predetermined correction amount of the selected injection molding machine; and outputting the generated second analysis condition.

### BACKGROUND

The present invention relates to an injection molding analysis method and an injection molding analysis system.

Japanese Patent Application Publication No. 2000-355033 discloses a technique of predicting a phenomenon during molding and the quality of molded articles by analyzing injection molding in an injection molding machine. In Japanese Patent Application Publication No. 2000-355033, the injection pressure curve of molding conditions is obtained by a simple method using the analysis result of a resin flow according to CAE (Computer Aided Engineering). Japanese Patent Application Publication No. 2000-355033 describes “A resin flow analysis in a mold is performed according to, for example, CAE and a resin pressure curve Ps at a resin flow inlet or a resin pressure curve Pn at the nozzle end of a molding machine is obtained. Injection (air shot) is conducted with a nozzle removed from the mold and an injection pressure curve Pa detected at that time is obtained. According to the injection pressure curve Pa and the resin pressure curve Ps or Pn, an injection pressure command curve P is obtained as a molding condition in volume production. For the resin pressure curves Ps and Pn obtained by the resin flow analysis, a time delay and a pressure loss that are caused by the machine elements of an injection molding machine are compensated by the injection pressure curve Pa of air shot, thereby easily the molding conditions of volume production molding.”

### SUMMARY

In the method of Japanese Patent Application Publication No. 2000-355033, a time delay and a pressure loss that are caused by the machine elements of the injection molding machine are compensated for the resin pressure curve obtained by the resin flow analysis, so that the molding conditions in volume production molding are obtained. Thus, in Japanese Patent Application Publication No. 2000-355033, a difference specific to the injection molding machine (machine difference) is not considered in the resin flow analysis. In other words, in Japanese Patent Application Publication No. 2000-355033, a resin flow is analyzed regardless of a machine difference specific to each injection molding machine and then a time delay or the like that is caused by the machine elements of the injection molding machine is compensated according to the analysis result, so that the molding conditions in volume production molding are obtained.

If the resin flow analysis is used for a product design, the molding conditions, a product structure, and a mold structure are optimized such that part quality predicted from the analysis result satisfies requirement specifications. However, in the resin flow analysis conducted regardless of a machine difference of the injection molding machine as described in Japanese Patent Application Publication No. 2000-355033, the accuracy of prediction of part quality or the like may fall below that of actual molding. This is because even if injection molding machines are manufactured in the same design, each of the machines actually has a small specific machine difference that affects the behavior of resin.

Thus, in resin flow analysis conducted regardless of a machine difference specific to the injection molding machine as described in Japanese Patent Application Publication No. 2000-355033, it is difficult to determine the optimum values of molding conditions, a product structure, and a mold structure. Even if an optimum value is determined, the value may be different from an optimum value in actual molding.

The present invention has been devised in view of the problem. An object of the present invention is to provide an injection molding analysis method and an injection molding analysis system that can accurately analyze an injection molding machine.

In order to solve the problem, the injection molding analysis method according to the present invention is a method of generating the analysis conditions of an injection molding machine by using at least one computer, the at least one computer executing the steps of: selecting one of injection molding machines, each being associated with a predetermined correction amount of injection molding; generating a second analysis condition for the selected injection molding machine on the basis of an acquired first analysis condition and the predetermined correction amount of the selected injection molding machine; and outputting the generated second analysis condition.

According to the present invention, the second analysis condition for the selected injection molding machine can be generated on the basis of the predetermined correction amount associated with the selected injection molding machine and the first analysis condition.

### BRIEF DESCRIPTION OF THE DRAWINGS

FIG. 1 is a functional block diagram of an injection molding analysis system;

FIG. 2 is an explanatory drawing illustrating a hardware configuration and a software configuration of a computer usable for implementing the injection molding analysis system;

FIG. 3 is a cross-sectional view illustrating the configuration of an injection molding machine;

FIG. 4 is a flowchart of an injection molding analysis;

FIG. 5 is a flowchart showing the detail of processing for correcting analysis conditions;

FIG. 6 is an explanatory drawing illustrating the outline of an experiment for verifying the effect of the present embodiment;

FIG. 7 is a block diagram indicating a method of acquiring a correction amount of the molding machine;

FIG. 8 is a graph showing that the relationship between a set value of a dwell pressure and a peak pressure varies between molding machines;

FIG. 9 is a graph showing that the relationship between a resin temperature and a peak resin temperature varies between the molding machines;

FIG. 10 is a functional block diagram of an injection molding analysis system according to Embodiment 2;

FIG. 11 is a flowchart showing the detail of processing for correcting analysis conditions;

FIG. 12 is a flowchart of processing for determining whether a necessary clamping force exceeds the threshold value of a clamping force;

FIG. 13 is a graph showing a change in mold opening amount with respect to time;

FIG. 14 is a graph showing the relationship between a set value of a dwell pressure and a remaining mold opening amount;

FIG. 15 illustrates an example of a screen provided for a user in order to correct analysis conditions according to Embodiment 3;

FIG. 16 illustrates an example of a screen of flow analysis software that is executed according to the corrected analysis conditions;

FIG. 17 is an overall block diagram of an injection molding analysis system according to Embodiment 4; and

FIG. 18 is an overall block diagram of an injection molding analysis system according to Embodiment 5.

### DETAILED DESCRIPTION OF THE EMBODIMENT

Embodiments of the present invention will be described below in accordance with the accompanying drawings. In the present embodiment, a difference (machine difference) specific to an injection molding machine is reflected in advance in analysis conditions and then an analysis is conducted, ensuring the accuracy of the analysis. Specifically, in an injection molding analysis method according to the present embodiment, a predetermined correction amount is calculated in advance for a machine difference specific to the injection molding machine and is stored so as to be associated with the injection molding machine. In the injection molding analysis method according to the present embodiment, any molding machine is selected and a correction molding condition (second analysis condition) is generated on the basis of a predetermined correction amount for the selected injection molding machine and an inputted molding condition (first analysis condition). In the injection molding analysis method according to the present embodiment, a resin flow is analyzed using the corrected molding (second analysis condition).

The present embodiment achieves an injection molding analysis method that can predict a molding phenomenon and part quality with higher accuracy than the related art by correcting a machine difference specific to the injection molding machine. This can determine the optimum value of molding conditions where part quality satisfies requirement specifications, the optimum value of a product structure, and the optimum value of a mold structure with higher accuracy than the related art, improving reliability and usability.

In the present embodiment, a pressure and a temperature will be described as examples of a physical quantity for injection molding. The physical quantity may be a predetermined value or a curve (characteristic line) indicating a change of a value with respect to time. A pressure is added as a target in a temperature analysis because a heat generation process (e.g., shearing heat generation) in a mold is taken into consideration.

### Embodiment 1

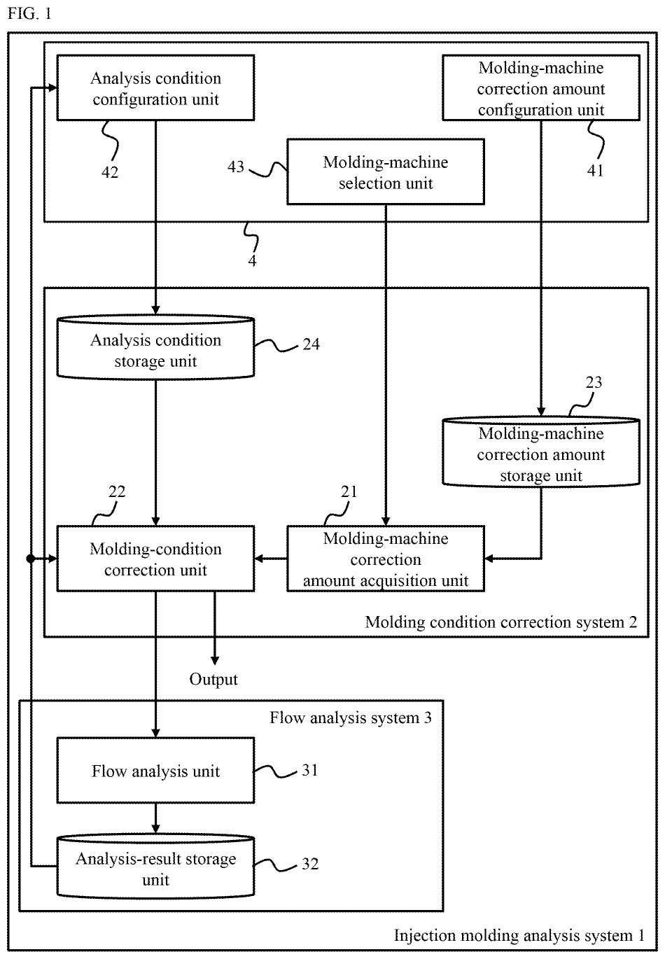

Referring to FIGS. 1 to 9, Embodiment 1 will be described below.

FIG. 1 is a functional block diagram of an injection molding analysis system 1. The injection molding analysis system 1 includes, for example, a molding condition correction system 2, a flow analysis system 3, and a configuration unit 4. At least some of functions constituting the injection molding analysis system 1 may be configured as software or cooperation between software and hardware. Hardware to be used may have a fixed circuit or may change at least a part of a circuit. At least a part of the configuration unit 4 may be configured as, for example, a user interface.

The molding condition correction system 2 has the function of generating corrected analysis conditions by correcting molding conditions included in inputted analysis conditions on the basis of a predetermined correction amount corresponding to a machine difference of an injection molding machine. Hereinafter, the predetermined correction amount may be abbreviated as a correction amount.

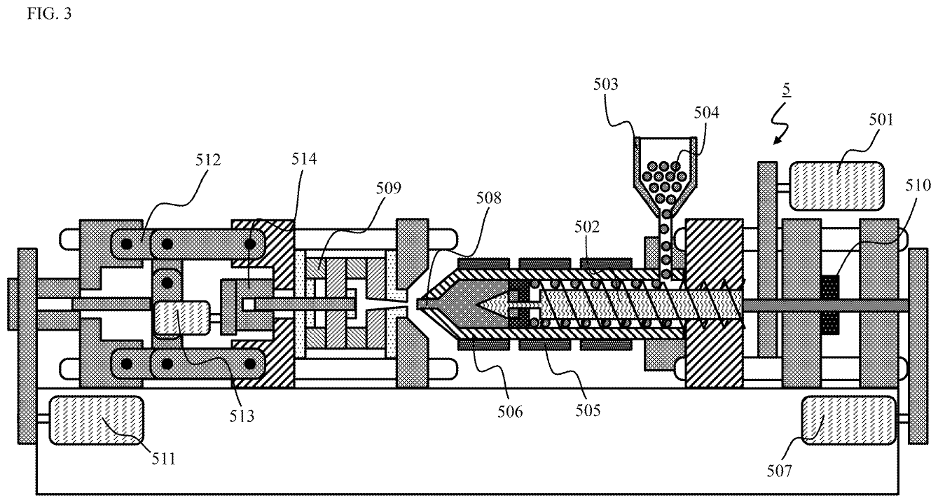

A machine difference in the present embodiment means, for example, a difference between inputted molding conditions and actual molding conditions in injection molding machines when the same molding conditions are inputted to the injection molding machines. The molding conditions include, for example, a pressure, a temperature, a speed, and material properties of resin at the resin inlet of a mold. The material properties include, for example, a resin density, a viscosity, and the distribution of fiber lengths (a material containing reinforcement fibers). It is assumed that a machine difference is caused by a difference in the control algorithm of pressure control or temperature control and the like and a difference between incidental facilities such as a mold temperature regulator, which is not illustrated, in addition to a difference in the configuration of an injection molding machine 5 that will be illustrated later in FIG. 3.

The molding condition correction system 2 includes, for example, a molding-machine correction amount acquisition unit 21, a molding-condition correction unit 22, a molding-machine correction amount storage unit 23, and an analysis-condition storage unit 24.

The molding-machine correction amount acquisition unit 21 is a function of reading and acquiring a correction amount from the molding-machine correction amount storage unit 23, the correction amount being previously associated with the injection molding machine selected by a molding-machine selection unit 43 of the configuration unit 4.

The molding-condition correction unit 22 has the function of correcting molding conditions, which are included in analysis conditions stored in the analysis-condition storage unit 24, on the basis of the correction amount from the molding-machine correction amount acquisition unit 21. The analysis conditions before the correction are an example of “first analysis conditions.” The analysis conditions including the molding conditions corrected by the molding-condition correction unit 22 are an example of “second analysis conditions.” The analysis conditions including the corrected molding conditions (also referred to as corrected analysis conditions) are inputted to the flow analysis system 3. The corrected analysis conditions can be also outputted to a display or an information processor, which is not illustrated.

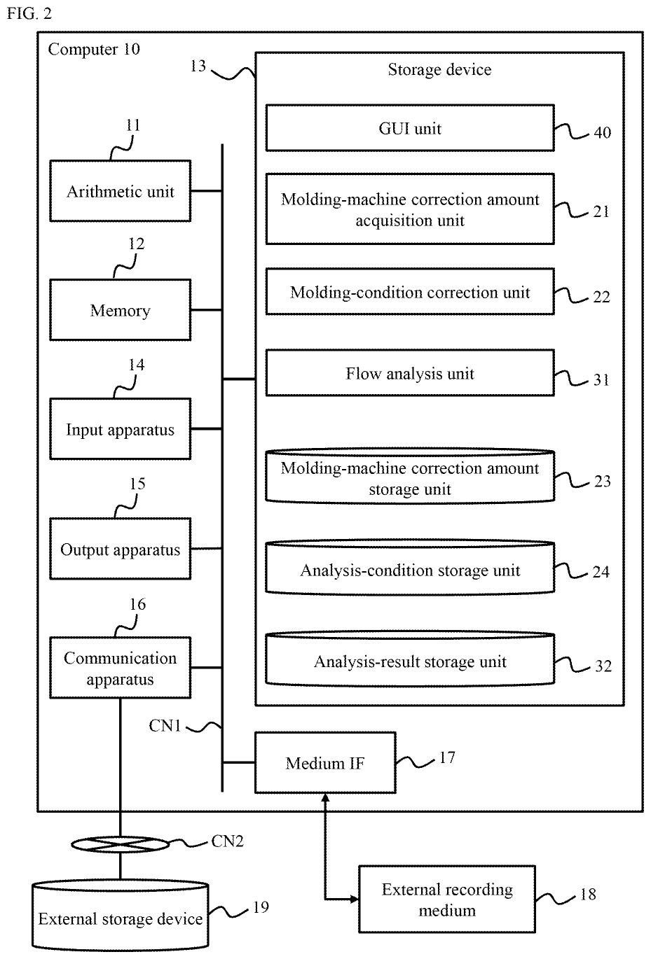

The molding-machine correction amount storage unit 23 is a function of storing a correction amount in a storage device (e.g., a storage device 13 that will be illustrated with FIG. 2). The correction amount is configured by a molding-machine correction amount configuration unit 41 of the configuration unit 4 and corresponds to a machine difference specific to each injection molding machine.

The analysis-condition storage unit 24 is a function of storing analysis conditions, which are configured by an analysis condition configuration unit 42 of the configuration unit 4, in the storage device.

The flow analysis system 3 has the function of analyzing, for example, a resin flow in the injection molding machine selected by the molding-machine selection unit 43, on the basis of the analysis conditions corrected by the molding condition correction system 2. The flow analysis system 3 includes, for example, a flow analysis unit 31 that executes a flow analysis and an analysis-result storage unit 32 that stores, in the storage device, the result of the analysis performed by the flow analysis unit 31. The flow analysis unit 31 analyzes a molding phenomenon and part quality in the analysis area of the selected injection molding machine on the basis of the corrected analysis conditions and stores the analysis result in the analysis-result storage unit 32.

The configuration unit 4 is a function of causing the molding condition correction system 2 to configure information used for correcting the molding conditions. The configuration unit 4 can be implemented using a GUI (Graphical User Interface) unit 40, which will be illustrated with FIG. 2. The configuration unit 4 includes, for example, the molding-machine correction amount configuration unit 41, the analysis condition configuration unit 42, and the molding-machine selection unit 43.

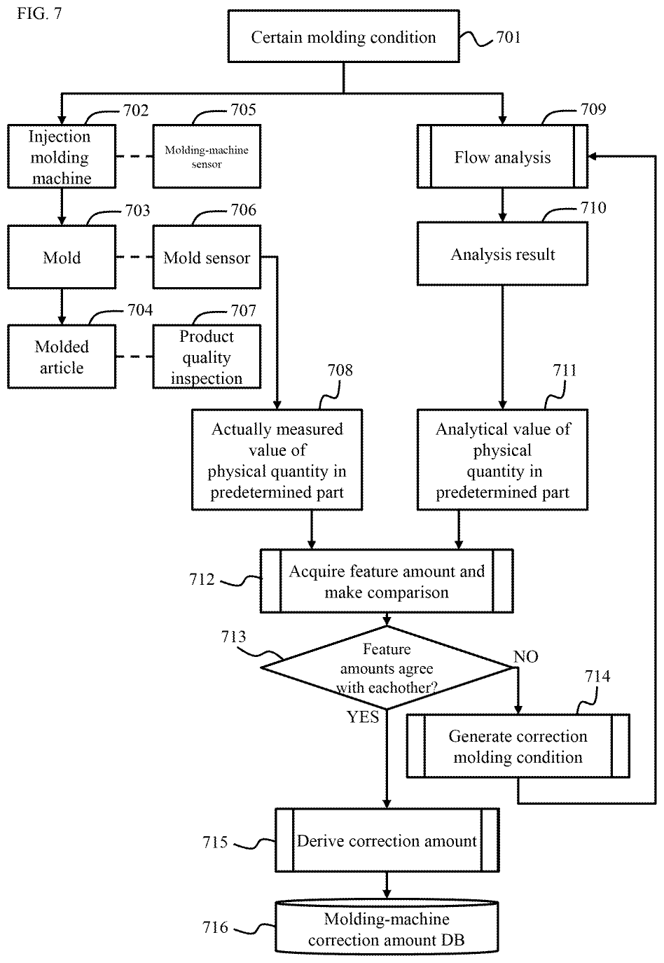

The molding-machine correction amount configuration unit 41 has the function of causing the molding condition correction system 2 to configure a correction amount corresponding to a machine difference specific to each injection molding machine. An example of a calculation method of a correction amount will be illustrated with FIG. 7. The analysis condition configuration unit 42 has the function of causing the molding condition correction system 2 to configure conditions for analyzing the injection molding machine to be analyzed. The molding-machine selection unit 43 has the function of selecting the injection molding machine to be analyzed and causes the molding condition correction system 2 to configure the injection molding machine.

The analysis conditions before the correction, a correction amount specific to the injection molding machine, and information for specifying the injection molding machine may be manually configured by the operator through the GUI or may be configured by the information processor, which is not illustrated, in an automatic or semiautomatic manner.

The analysis conditions include information on an analysis structure, molding conditions, and molding materials. The analysis structure includes, for example, a mold shape.

FIG. 2 illustrates a configuration example of a computer 10 usable for implementing the injection molding analysis system 1. In this example, the injection molding analysis system 1 is implemented by the single computer 10. Multiple computers may be combined to construct at least one injection molding analysis system 1.

The computer 10 includes, for example, an arithmetic unit 11, a memory 12, a storage device 13, an input apparatus 14, an output apparatus 15, a communication apparatus 16, and a medium interface unit 17. The units, device, and apparatuses 11 to 17 are coupled to one another via a communication channel CN1. The communication channel CN1 is, for example, an internal bus or a LAN (Local Area Network). The computer 10 may be, for example, a cloud computer or a computer in the same manufacturing scene as the injection molding machine 5. In the following explanation, various kinds of processing are implemented by the single computer 10. Multiple computers 10 may cooperate to implement the processing of the embodiment.

The arithmetic unit 11 includes, for example, a microcomputer. The arithmetic unit 11 reads computer programs, which are stored in the storage device 13, into the memory 12 and executes the programs so as to implement functions 21 to 24, 31, 32, and 40 as the injection molding analysis system 1.

The storage device 13 is a device for storing the computer programs and data. The storage device 13 includes, for example, rewritable storage media such as a flash memory and a hard disk. In the storage device 13, a computer program for implementing the GUI unit 40 that provides the GUI for the operator is stored and the computer programs for implementing the functions 21 to 24, 31, and 32 are stored.

The input apparatus 14 is an apparatus for inputting information to the computer 10 by the operator. The input apparatus 14 is, for example, a keyboard, a touch panel, a pointing device such as a mouse, or a voice command device (any one of the devices is not illustrated). The output apparatus 15 is an apparatus for outputting information from the computer 10. The output apparatus 15 is, for example, a display, a printer, or a voice synthesizer (any one of the devices is not illustrated).

The communication apparatus 16 is an apparatus for communications between an external information processor and the computer 10 via a communication network CN2. As the external information processor, an external storage device 19 is available in addition to the computer that is not illustrated. The computer 10 can read data (a correction amount and information on the injection molding machine) and the computer programs that are stored in the external storage device 19. The computer 10 can also transmit, to the external storage device 19, at least part of the computer programs and data that are stored in the storage device 13 and then store the programs and data in the external storage device 19.

The medium interface unit 17 is an apparatus for reading and writing in an external recording medium 18. The external recording medium 18 is, for example, a USB (Universal Serial Bus) memory, a memory card, or a hard disk. The computer programs and data can be also transferred from the external recording medium 18 to the storage device 13 and at least part of the computer programs and data that are stored in the storage device 13 can be also transferred to the external recording medium 18 and stored therein.

Referring to a schematic diagram of the injection molding machine 5 in FIG. 3, the steps of an injection molding process will be described below. In the present embodiment, a molding phenomenon indicates a series of phenomena that occur in the injection molding process. In the present embodiment, the injection molding process is broadly divided into the step of measurement and plasticization, the step of injection and dwelling, the step of cooling, and the step of removal.

In the step of measurement and plasticization, a screw 502 is retracted by a plasticizing motor 501 acting as a driving force, so that resin pellets 504 are supplied from a hopper 503 into a cylinder 505. Subsequently, heat from the heater 506 and the rotation of the screw 502 plasticize resin into a uniform molten state. The density of molten resin and the degree of fracture of reinforcement fibers vary according to the back pressure and the number of revolutions of the screw 502. These changes affect part quality.

In the step of injection and dwelling, the screw 502 moved ahead by the plasticizing motor 507 acting as a driving force, so that the molten resin is injected into a mold 509 through a nozzle 508. The molten resin injected into the mold 509 is simultaneously subjected to cooling from the wall surface of the mold 509 and shearing heat generation caused by a flow. In other words, the molten resin flows into the cavity of the mold 509 while being cooled and heated.

After the molten resin is charged into the mold 509, resin is supplied into the mold 509 by a dwell pressure according to a volume reduction during cooling of the molten resin. If a clamping force for closing the mold 509 is small relative to a pressure during injection and a pressure during dwelling, the mold slightly opens after the molten resin is solidified. The part quality is affected by a small gap.

In the step of cooling, the molten resin is cooled to a solidifying point or less by the mold 509 kept at a constant temperature. A residual stress generated in the step of cooling affects the part quality. The residual stress is generated with the anisotropy of material properties due to a flow in the mold, a density distribution caused by a dwell pressure, and irregularities in mold shrinkage factors.

In the step of removal, a clamping mechanism 512 is driven by a motor 511 acting as a driving force so as to open and close the mold 509, so that the mold 509 is opened. Subsequently, an ejector mechanism 514 is driven by an ejection motor 513 acting as a driving force, so that the solidified part is removed from the mold 509. The mold 509 is then closed for a subsequent shot. If a sufficient ejection force is not evenly applied to the part when the part is removed from the mold 509, a residual stress is left on the part and affects the part quality.

An ordinary resin flow analysis of the related art is aimed only at a resin flow in a mold and the states of other injection molding machines are not taken into consideration. Thus, the step of measurement and plasticization and the step of removal are not taken into consideration. Furthermore, in the step of injection and dwelling, the cylinder 505 and the nozzle 508 are not taken into consideration and the temperature, pressure, and speed of molten resin at the resin inlet of the mold 509 are provided as boundary conditions and are analyzed.

In the injection molding machine 5, pressure control is performed such that a pressure value determined by a load cell 510 approaches a pressure value under inputted molding conditions. The temperature of the cylinder 505 is controlled by a plurality of heaters 506. A different pressure loss is produced for each injection molding machine depending upon the shape of the screw 502, the shape of the cylinder 505, and the shape of the nozzle 508. Thus, a pressure at the resin inlet of the mold 509 is lower than a pressure indicated by the molding conditions inputted to the injection molding machine. Moreover, because of the layout of the heaters 506 and the shearing heat generation of resin in a nozzle part, a resin temperature at the resin inlet of the mold 509 may be different from a resin temperature indicated by the molding conditions inputted to the injection molding machine. The configuration of the injection mechanism (including the shape of the screw 502, the shape of the cylinder 505, the shape of the nozzle 508, and the layout of the heaters 506) varies among injection molding machines. Therefore, a resin flow analysis can be accurately conducted by correcting the boundary conditions of molten resin at the resin inlet of the mold 509 according to a machine difference.

The part quality is evaluated by shape characteristics (including a weight, a length, a thickness, a shrink mark, a burr, and a warp), surface characteristics such as poor appearances (including a weld, silver, burning, bleaching, air bubbles, exfoliation, a flow mark, jetting, and a color/shine), and mechanical and optical properties (including tensile strength and impact resistance). These quality evaluation items are merely exemplary. The quality may be evaluated by other items and it is not necessary to evaluate all the items.

The shape characteristics are highly associated with the history of a pressure and a temperature and a clamping force in the step of injection and dwelling and the step of cooling. The surface characteristics are caused by different factors depending on occurring phenomena. For example, a flow mark and jetting are highly associated with a temperature and speed of resin in the step of injection. Regarding the mechanical and optical properties, for example, tensile strength requires an evaluation by destructive testing and thus the properties are frequently evaluated by other associated quality indexes such as a weight.

In the molding conditions, a parameter is configured for each step of the injection molding process. In a resin flow analysis, parameters are mainly configured as follows: in the step of measurement and plasticization, a measurement position is configured if the screw diameter of the injection molding machine is defined. In the step of injection and dwelling, a pressure, a temperature, a time, and a speed at the resin inlet of the mold 509 are configured. In the step of injection and dwelling, a screw position (VP switching position) for switching injection and dwelling is also configured. In the step of cooling, a cooling time after dwelling is configured. In a calculation including a temperature distribution in the mold, the boundary conditions are configured. The boundary conditions include, for example, a temperature and a flow rate of a refrigerant and a surface temperature of the mold.

In a flow analysis, a molding phenomenon is calculated on the basis of the set value (input value) of the molding conditions and the part quality is predicted on the basis of the calculation result. The accuracy of the flow analysis can be obtained by a comparison between the analytical value of a predetermined parameter and an actually measured value and a comparison between part quality predicted by analysis and actually measured part quality. The predetermined parameter is, for example, a pressure, a temperature, a speed, and a change of material characteristics with respect to time in each step of a molding phenomenon. As described above, the part quality is evaluated by, for example, dimensions, an amount of warp, a burr, a scratch, a shine, and a color.

For example, the accuracy of dimensions is evaluated by comparing an actually measured value on a predetermined part to be measured in a molded article and the analytical value of the predetermined part.

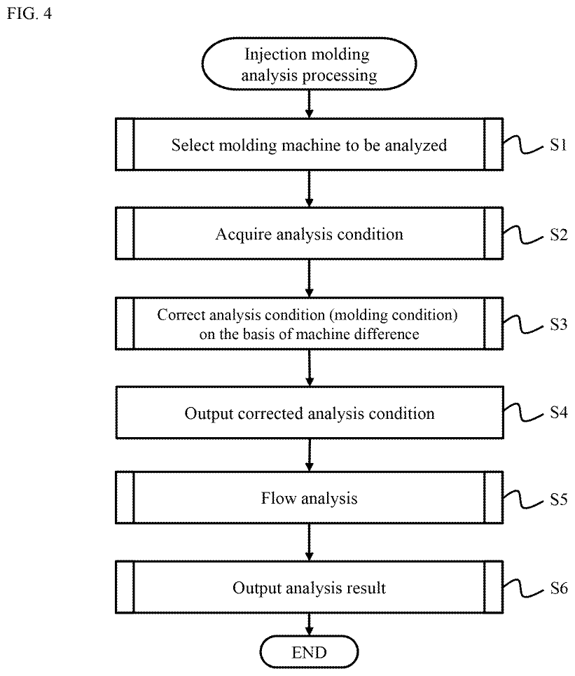

FIG. 4 is a flowchart of an example of a flow analysis method.

The molding condition correction system 2 acquires information for specifying the injection molding machine to be analyzed, from the molding-machine selection unit 43 implemented by the GUI unit 40 (S1). The injection molding machine to be analyzed can be manually selected by the operator. For the injection molding machine selectable as a target of analysis, a correction amount based on a specific machine difference is calculated in advance. The calculated correction amount is stored in the molding-machine correction amount storage unit 23.

The correction amount in the present embodiment is a value for correcting the inputted molding conditions according to the machine difference of the selected injection molding machine. For example, the operator can select the injection molding machine to be analyzed (e.g., the injection molding machine to be used in production) from a list of injection molding machines displayed on the GUI (S1). In this example, one of the injection molding machines is selected. Two or more injection molding machines may be selected.

The molding condition correction system 2 acquires analysis conditions from the analysis condition configuration unit 42 implemented by the GUI unit 40 (S2). The analysis conditions include at least one condition used for analysis in the flow analysis system 3 in addition to the information for specifying the injection molding machine acquired in step S1. The conditions include, for example, the molding conditions, the kind of resin material, the model shapes and mesh division conditions of a molded article and the mold, and calculation conditions.

In the analysis conditions acquired in step S2, the same set value as the set value to be used in actual production can be used regardless of a machine difference of the injection molding machine. In other words, the operator can input the analysis conditions to the molding condition correction system 2 regardless of a machine difference of each of the injection molding machines.

Referring to the molding conditions in the analysis conditions stored in the analysis-condition storage unit 24 and the information for specifying the injection molding machine to be analyzed (molding machine information), the molding-condition correction unit 22 corrects the molding conditions by using a correction amount associated with the injection molding machine to be analyzed (S3).

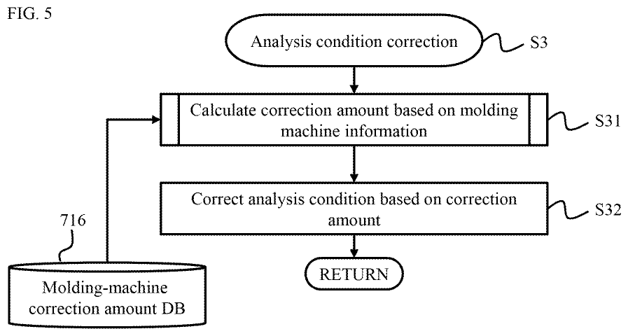

As shown in FIG. 5, in step S3, the correction amount is calculated using the molding conditions and the molding machine information as input values (S31). Specifically, the molding-condition correction unit 22 searches a correction amount database 716, which is stored in the molding-machine correction amount storage unit 23, for the molding machine information used as a retrieval key, so that a correction amount specific to the injection molding machine is acquired. The molding conditions are corrected on the basis of the acquired correction amount (S32).

The process returns to FIG. 4. In the step S3, when the operator provides the molding condition correction system 2 with an instruction to start correction from the GUI unit 40, the molding-condition correction unit 22 corrects the molding conditions. In other words, the molding-condition correction unit 22 generates corrected molding conditions.

The corrected molding conditions can be also outputted from, for example, the output apparatus 15 (S4). This allows the operator to confirm the contents of the corrected molding conditions. The contents of the corrected molding conditions may be confirmed before, during, or after a flow analysis conducted by the flow analysis system 3. Even if the operator does not confirm the contents of the corrected molding conditions, a flow analysis can be conducted in consideration of a machine difference specific to the injection molding machine 5. In any case, the molding conditions having been corrected (corrected molding conditions) are desirably stored in the analysis-result storage unit 32 so as to be referred to after the analysis. The analysis conditions including the corrected molding conditions can be referred to as correction analysis conditions. The correction analysis conditions are an example of “second analysis conditions.”

When the instruction to start analysis is inputted from the operator through the GUI unit 40, the flow analysis unit 31 conducts a flow analysis using the corrected analysis conditions as input values (S5). The obtained molding phenomenon and part quality are stored in the analysis-result storage unit 32 (S6).

In response to the instruction from the operator, the analysis-result storage unit 32 can also output the obtained molding phenomenon and part quality from the output apparatus 15 (S6). The operator can determine, for example, whether the part quality satisfies the requirement specifications of a product by referring to the output result of the flow analysis.

If the part quality obtained as the result of the flow analysis does not satisfy target requirement specifications or optimum molding conditions are expected, the process may return to step S2. The operator can correct at least part of the molding conditions, an analysis mechanism, and the material and then conduct a flow analysis again so as to obtain optimum molding conditions.

For example, if molding is scheduled to be performed by multiple injection molding machines, steps S1 to S6 can be repeated for each of the injection molding machines in order to correct a machine difference for each of the injection molding machines and obtain uniform part quality. Alternatively, multiple injection molding machines may be registered in an analysis group and a flow analysis may be conducted in consideration of machine differences simultaneously on the injection molding machines registered in the analysis group.

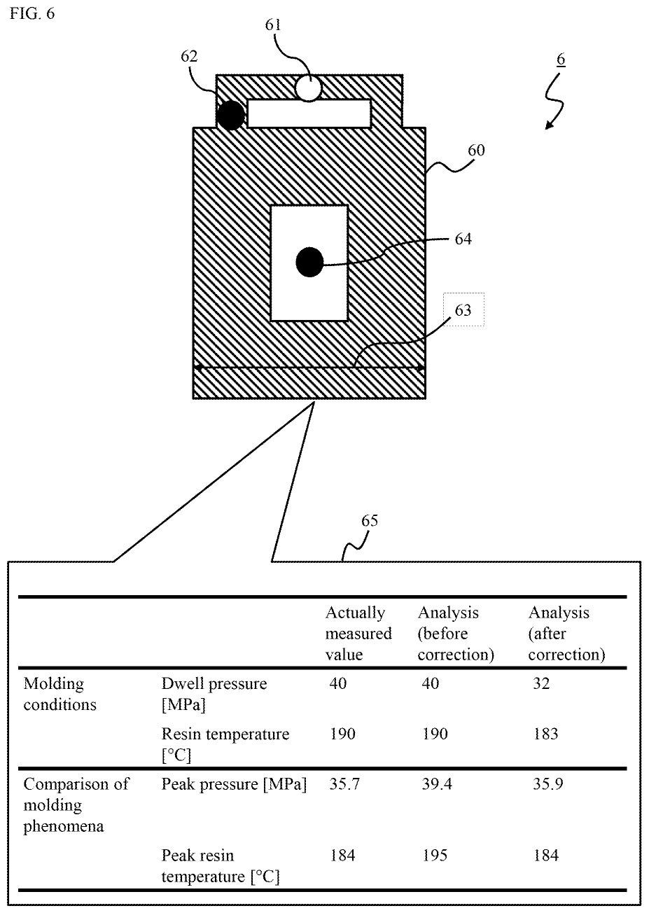

FIG. 6 is an explanatory drawing illustrating the outline of experimental example 6 for examining the effect of the present embodiment. The upper part of FIG. 6 illustrates a status of an experiment. The lower part of FIG. 6 shows a table of experimental results. The table includes some of the input values of the molding conditions and evaluation results in the verification experiment.

A mold shape 60 in the upper part of FIG. 6 has a structure in which resin flows into a cavity from a sprue 61 according to a side-gate system of two points. In an actual molding experiment, a pressure sensor and a resin temperature sensor (the sensors are not illustrated) were disposed in a sensor installation part 62 of a runner. Moreover, a change of a pressure and a change of a temperature with respect to time in the cavity were obtained as molding phenomena.

From data obtained by the experiment, the peak value of the pressure sensor and the peak value of the temperature sensor were acquired as “feature amounts”. As an index of part quality, a lateral dimension 63 of the obtained part was measured. Also in a flow analysis, a molding phenomenon and part quality were acquired at the same position and the effect of improving the accuracy of analysis according to the present embodiment was confirmed. A material used for molding was polypropylene. The injection molding machine was a motor-driven injection molding machine (a maximum clamping force of 50 t and a screw diameter of 26 mm).

Referring to the table in the lower part of FIG. 6, a comparison between an actually measured value and an analytical value before correction proved that the analytical value before correction has a higher peak pressure and a lower peak resin temperature. Regarding an analytical value after correction, a peak pressure and a peak resin temperature in the sensor installation part 62 were substantially equal to actually measured values (the accuracy of a peak pressure was increased by 10% and the accuracy of a peak resin temperature was increased by 6%). The accuracy of analysis of the lateral dimension 63 was increased by 12% after the correction. This result was obtained by inputting the corrected molding conditions to the flow analysis system 3, the molding conditions including a dwell pressure and a resin pressure that are corrected according to an acquired correction amount.

FIG. 7 is a block diagram indicating an example of a method of acquiring a correction amount according to a machine difference specific to the injection molding machine. The method of acquiring a correction amount in FIG. 7 is implemented by using, as shown in FIG. 6, “a mold with an attached sensor” or “a mold with a built-in sensor” in which the sensor measures a predetermined physical quantity at a predetermined position.

A certain molding condition 701 is first inputted to an actual injection molding machine 702 and a flow analysis 709, thereby acquiring a physical quantity necessary for obtaining a correction amount. In this case, the injection molding machine 702 corresponds to the injection molding machine 5 illustrated in FIG. 3. The flow analysis 709 corresponds to the processing of the flow analysis unit 31. The molding condition 701 corresponds to the molding condition included in the analysis conditions inputted from the analysis condition configuration unit 42 to the analysis-condition storage unit 24.

The molding condition 701 may be replaced with multiple conditions. A flow analysis can be conducted under various molding conditions as long as a conforming article is obtained with part quality.

The correction amount may vary according to the set value of a resin temperature or a dwell pressure and thus frequently becomes invalid even under the single molding condition. Under the molding condition 701, dwelling is preferably completed after gate sealing. This is because if a dwell time is insufficient and dwelling is completed before gate sealing, resin may flow backward from a gate part and reduce the packing density of a molded article. In this case, the accuracy of prediction of part quality may decrease.

In order to acquire a molding phenomenon in the actual injection molding machine 702, a molding-machine sensor 705 or a mold sensor 706 is used in a method. The load cell 510 in FIG. 3 is an example of the molding-machine sensor 705.

In the use of the molding-machine sensor 705, for example, an air shot is made for injection without the mold 703 and the output of the load cell 510 at that time is observed, allowing an indirect measurement of a pressure loss caused by the injection mechanism. Alternatively, a sensor is installed in the nozzle part and measures a state of resin immediately before the resin flows into the mold.

In the use of the mold sensor 706, the sensor is disposed at any position in a mold 703, allowing a direct measurement of a molding phenomenon in the mold 703 and acquisition of an actually measured value 708 of a physical quantity. As described above, a flow analysis is aimed at a resin flow at or downstream of the inlet of the mold and thus a physical quantity at any position can be directly compared by using the mold sensor. Hence, from a result 710 of a flow analysis, an analytical value 711 of a physical quantity is acquired in a part where the mold sensor 706 is installed. The quality of a molded article 704 can be acquired by a product quality inspection 707.

From the acquired actual measured value of the physical quantity and the analytical value, a feature amount for comparing the actually measured value and the analytical value is acquired (712). The obtained physical quantities are both acquired as changes in the injection molding process with respect to time, so that it is difficult to directly compare the physical quantities. Thus, in the present embodiment, a feature amount that may affect part quality is acquired from a change of a physical quantity with respect to time. This achieves a quantitative comparison between the actually measured value and the analytical value.

Subsequently, it is determined whether the actually measured value and the analytical value of the feature amount of a physical quantity agree with each other (713). If the values do not agree with each other (713: NO), a corrected molding condition is generated by correcting the analysis condition such that the analytical value of the feature amount agrees with the actually measured value (714). Processing from the flow analysis 709 to the generation of the corrected molding condition 714 is repeatedly performed using the corrected molding conditions until feature amounts agree with each other.

If the feature amounts agree with each other (713: YES), a correction amount is calculated from a difference between the first acquired molding condition 701 and the corrected molding condition 714 (715). For example, if molding conditions and corrected molding conditions are obtained as in the table of the lower part of FIG. 6, the correction amount of a dwell pressure is −8 MPa and the correction amount of a resin temperature is −7° C.

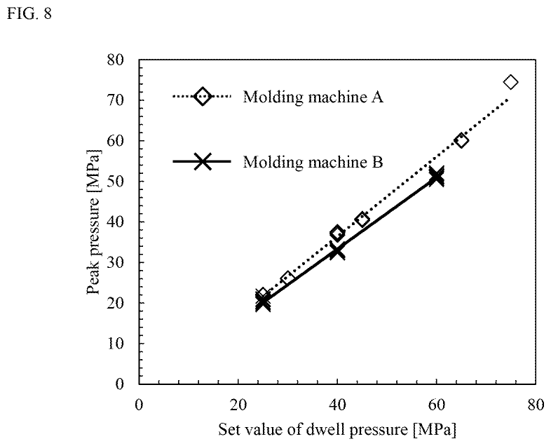

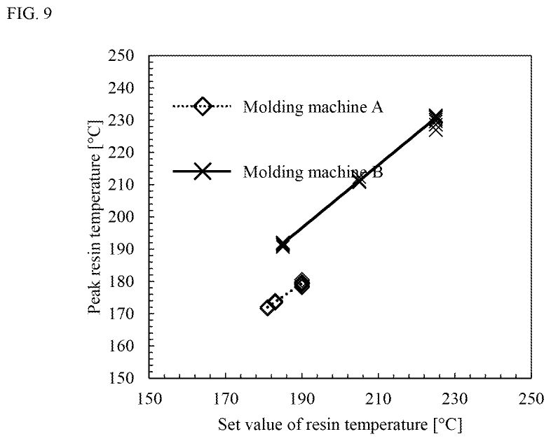

Referring to FIGS. 8 and 9, the measurement results of the experimental example in FIG. 3 will be described below. FIGS. 8 and 9 show the measurement results of the mold shape 60 when the actually measured value of a physical quantity is acquired by using the mold sensor 706.

As described above, in this experiment, the peak value of the pressure sensor and the peak value of the resin temperature sensor were acquired in the sensor installation part 62 of the runner. “Molding machine A” indicated by diamond-shaped measurement points is an injection molding machine having a maximum clamping force of 50 t and a screw diameter of 26 mm. “Molding machine B” indicated by cross measurement points is an injection molding machine having a maximum clamping force of 55 t and a screw diameter of 25 mm. Experiments were conducted on the input values of multiple dwell pressures and resin temperatures.

FIG. 8 shows a peak pressure of the pressure sensor relative to a set value of a dwell pressure. As shown in FIG. 8, a peak pressure value falls below a set value of a dwell pressure due to a pressure loss caused by the injection mechanism. The two molding machines A and B have different inclinations of a set value of an obtained dwell pressure and a peak pressure. Thus, a pressure correction value is preferably acquired under multiple molding conditions.

FIG. 9 shows a peak temperature of the resin temperature sensor relative to a set value of a resin temperature. As shown in FIG. 9, the molding machine A and the molding machine B had different peak temperature values relative to a set value because of a difference in injection mechanism. In this way, the actually measured value of a physical quantity is acquired by using the mold sensor 606, allowing a direct evaluation of a machine difference near the inlet of the mold. This can accurately determine a correction amount necessary for a flow analysis.

A part for measuring a physical quantity in the mold will be described below (hereinafter, will be referred to as a measurement part). In each mold structure, the measurement part preferably includes at least a sprue part or a runner part that extends from the resin inlet into the cavity in the mold.

The cavity may contain the measurement part but when a correction amount is derived from the foregoing steps, it is necessary to consider a pressure loss from the resin inlet to the cavity. This requires the accuracy of analysis from the resin inlet to the inside of the cavity.

In the case of a measurement with the sensor in the cavity, a sensor shape may leave a mark on a molded article. Thus, in a place where a fine appearance is required, the introduction of the sensor is restricted.

Hence, in the present embodiment, the measurement part is set in the sprue part or the runner part that is located near the resin inlet and does not require a fine appearance, thereby easily determining a correction amount with high accuracy. In addition to the sprue part and the runner part, the measurement part may be a part where a characteristic flow is observable, for example, a part immediately below in the cavity, a resin joining part (weld part), or a flow end. In this case, a correction amount can be more accurately determined from physical quantities obtained by multiple sensors.

For example, the flow rate of molten resin can be determined from the time points of passage of a flow front in multiple measurement parts, thereby deriving a correction amount of a speed. Furthermore, a measurement of a pressure and a temperature at that time can estimate the viscosity of molten resin in the mold, allowing a comparison with an analysis model.

Proper measurement parts vary among mold structures. In any mold structure, if possible, a sprue part preferably serves as a measurement part. “Preferably” merely means an expectation of an enhanced effect but does not mean that the configuration is essential.

If it is difficult to provide a sensor in a sprue part in the design of a mold, the sensor may be disposed in a runner part. In the case of a direct gate, a runner part is not provided and thus a part nearest the inside of a cavity is selected as a measurement part.

In a side gate, a jump gate, a submarine gate, and a banana gate, a sensor is disposed in, for example, a runner part immediately below a sprue part or a runner part in front of the gate. In the case of a pin gate, a three-plate structure is provided and thus requires a devised sensor layout. A sensor is disposed in, for example, a runner part immediately below a sprue part. In the case of a pin gate, a dummy runner uncoupled to a cavity may be provided for measurement and serve as a measurement part. The provision of the part for measurement increases flexibility in mold design. In the case of a film gate or a fan gate, a sensor is disposed in a runner part ahead of an inlet to a gate part.

A parameter measured as the physical quantity will be described below. In the derivation of a correction amount of the present embodiment, at least a pressure and a temperature are measured. For example, a mold pressure sensor, a mold-surface temperature sensor, or a resin temperature sensor is usable for measuring a pressure and a temperature. As the resin temperature sensor, either one of or both of a contact temperature sensor such as a thermocouple and a noncontact temperature sensor such as an infrared radiometer may be used.

The physical quantities of a pressure and a temperature are changes recorded in the injection molding process with respect to time. Even if only a pressure is measured to derive a correction amount of the pressure, when a resin temperature is different from a set value as shown in FIG. 9, an analysis result different from an actual phenomenon may be obtained. Similarly, even if only a temperature is measured to derive a correction amount of the temperature, a pressure loss caused by the injection mechanism cannot be evaluated and thus the correction amount cannot be derived. Hence, a correction amount can be accurately determined by measuring at least both of a pressure and a temperature.

The injection molding analysis system 1 may acquire a flow-front speed or a time point of flow-front passage in addition to a temperature and a pressure. From the sensor that detects the speed and passage of a flow front, information on time points of flow-front passage can be obtained instead of a change in the injection molding process with respect to time. If a time point of flow-front passage is acquired, at least two sensors are provided to compare two time points of passage of resin. The detection of the speed and time point of flow-front passage enables the derivation of a correction amount of an injection speed with higher accuracy.

The feature amount of the physical quantity will be described below. The derivation of a correction amount of the present embodiment needs to include at least a maximum value and an integral value of a pressure and a maximum value of a temperature. The maximum value of a pressure is necessary for evaluating a pressure loss caused by the injection mechanism. However, even if only an actually measured value and an analytical value of the maximum value of a pressure agree with each other, a difference in the change of a resin temperature with respect to time in the dwelling step may change a pressure distribution in the cavity and thus affect the part quality.

Thus, a correction amount can be accurately derived in consideration of the influence of a temperature change in the process by acquiring the integral value of a pressure in the injection molding process. However, if a pressure change with respect to time in the dwelling step is analyzed and evaluated, a material model (viscosity and PVT characteristics) used for the analysis is desirably inputted with high accuracy. In the case of a material model having poor accuracy, changes in pressure with respect to time do not agree with each other even if changes in resin temperature in the process agree with each other. In this case, an improvement in the accuracy of the material model is examined.

If a correction amount is derived by changing, for example, a resin temperature only according to a feature amount obtained from a pressure, an analysis result different from an actual phenomenon may be obtained. Therefore, a correction amount is derived in consideration of the maximum value of a temperature in addition to a feature amount obtained from a pressure, so that the correction amount can be derived so as to obtain an analysis result according to an actual phenomenon.

Additionally, it is also effective to acquire the maximum value of a time derivative relative to a change in pressure with respect to time. The feature amount is associated with the instantaneous viscosity of a material. It is also effective to calculate the integral value of a pressure separately for the injection step and the dwelling step. The integral value of a pressure in the injection step is associated with the mean viscosity of a material in the injection step. These feature amounts are effective for verifying the accuracy of the material model.

If a resin temperature sensor of infrared radiation is used, it is also effective to acquire the maximum value of a time derivative relative to the output value of a change of the temperature sensor with respect to time in the injection step. The feature amount is associated with the flow-front speed of molten resin. Moreover, in a measurement of a flow-front speed, the speed is directly used as a feature amount associated with a flow rate. If a time point of flow-front passage is acquired, a flow rate is calculated from two time points of passage and is used as a feature amount. The use of these feature amounts enables the derivation of a correction amount of an injection speed with higher accuracy.

According to the present embodiment configured thus, a machine difference of the injection molding machine is analyzed by using corrected molding conditions, achieving an analysis with higher accuracy than in the related art. Furthermore, in the present embodiment, a correction amount is calculated and stored in advance on the basis of a machine difference specific to each injection molding machine, so that an operator only selects the injection molding machine to be analyzed, achieving an accurate analysis in consideration of a machine difference so as to improve usability and reliability.

The present embodiment enables an accurate analysis and thus can easily perform operations with higher accuracy than in the related art. For example, molding conditions are generated so as to satisfy the requirement specifications of part quality or optimum values are configured for a product structure and a mold structure. This can shorten a development period, thereby reducing the number of trials or a lead time at the start of volume production.

### Embodiment 2

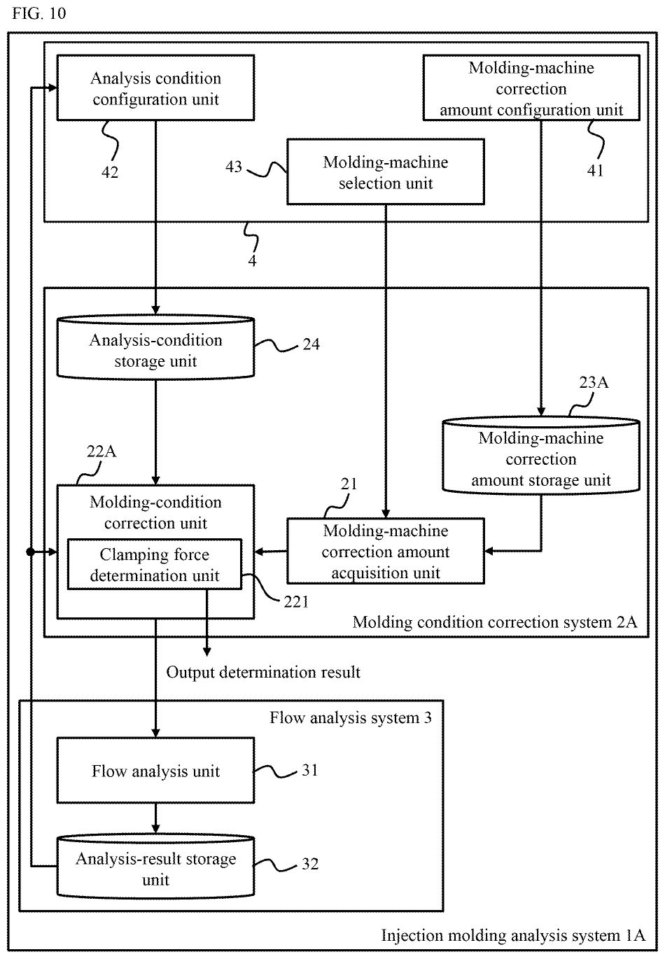

Referring to FIGS. 10 to 14, Embodiment 2 will be described below. In the following embodiments including the present embodiment, differences from Embodiment 1 will be mainly described.

FIG. 10 is a functional block diagram of an injection molding analysis system 1A according to the present embodiment. A comparison between the injection molding analysis system 1 in FIG. 1 and the injection molding analysis system 1A in FIG. 10 proves that a molding-condition correction unit 22A and a molding-machine correction amount storage unit 23A of a molding condition correction system 2A are different from those of the injection molding analysis system 1.

In the molding-machine correction amount storage unit 23A of the present embodiment, the threshold value of a clamping force corresponding to a machine difference is stored in addition to a correction amount corresponding to a machine difference for each injection molding machine. The molding-condition correction unit 22A of the present embodiment includes a clamping force determination unit 221 that determines a clamping force.

The clamping force determination unit 221 determines whether a necessary clamping force is larger than the threshold value of a clamping force. The necessary clamping force can be calculated from corrected molding conditions or can be determined from an analysis result. If it is determined that the necessary clamping force is larger than the threshold value, the determination result is outputted through an output apparatus 15.

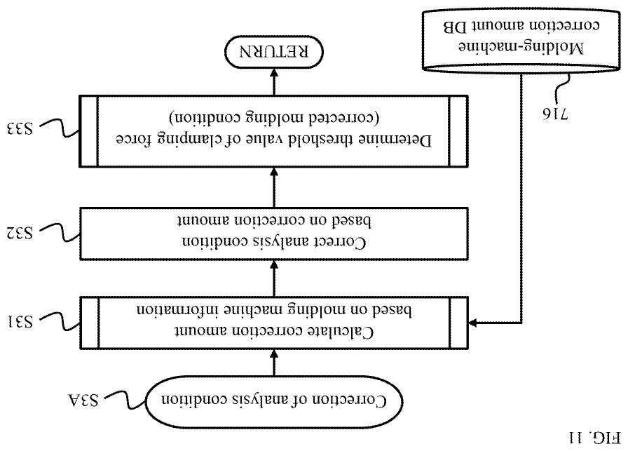

FIG. 11 is a flowchart showing the detail of step S3 for correcting analysis conditions. Step S3A is used instead of step S3 in FIG. 4. Step S3A includes a new step S33 in addition to steps S31 and S32. In step S33, as described above, it is determined whether the necessary clamping force exceeds the threshold value during the generation of the corrected molding conditions.

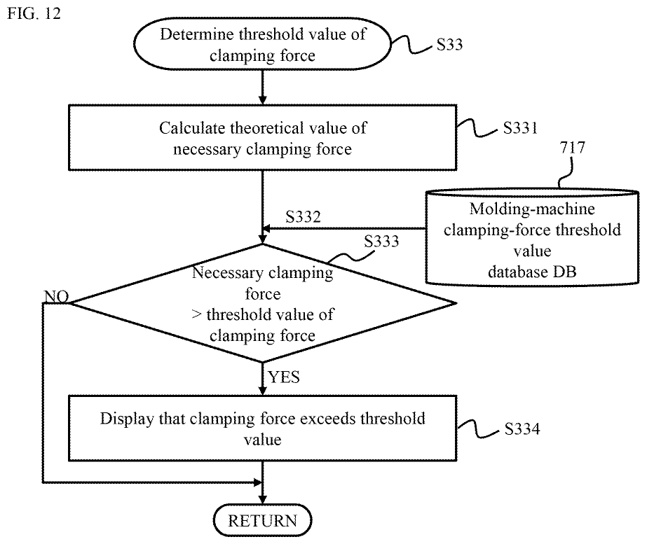

FIG. 12 is a flowchart showing the detail of step S33 in FIG. 11. The molding-condition correction unit 22A calculates the theoretical value of the necessary clamping force from the corrected molding conditions in step S33 (S331). A necessary clamping force F is determined by, for example, Expression (1) below.

F=PA (Expression 1)

Where “F” is a necessary clamping force, “P” is a pressure in a cavity, and “A” is a projection area. The pressure in the cavity is a higher value of an injection pressure in the corrected molding conditions or a pressure in the step of dwelling.

Referring to a molding-machine clamping-force threshold value database 717 stored in advance in the molding-machine correction amount storage unit 23A, the molding-condition correction unit 22A acquires the threshold value of a clamping force specific to a selected injection molding machine (S332).

The molding-condition correction unit 22A compares the necessary clamping force obtained in step S331 and the obtained threshold value of a clamping force in step S332 (S333). If it is determined that the necessary clamping force exceeds the threshold value (S333: YES), the molding-condition correction unit 22A causes the output apparatus 15 to display the necessary clamping force exceeding the threshold value (S334).

In other cases (S333: NO), the processing is completed and the process returns to FIG. 11. If the necessary clamping force does not exceed the threshold value (S333: NO), the output apparatus 15 may be caused to display the necessary clamping force not exceeding the threshold value.

When confirming that the necessary clamping force exceeds the threshold value of a clamping force, an operator optionally returns to the step of selecting a molding machine in step S1 and selects another injection molding machine. Alternatively, the operator returns to the step of inputting analysis conditions in step S2 and corrects the analysis conditions so as to keep the necessary clamping force at the threshold value or smaller.

A calculated value of a necessary clamping force according to Expression (1) may serve as a threshold value in the configuration of a clamping force and molding conditions may be configured such that a clamping force in actual injection molding exceeds the threshold value. However, even if the clamping force is configured thus, the clamping force actually becomes insufficient due to a machine difference specific to the injection molding machine. This may affect a molding phenomenon and part quality. In this way, a machine difference of the molding machine affects a difference of a stress actually applied to a mold as well as a difference in resin state when the same molding conditions are inputted to multiple molding machines.

In a normal flow analysis, only a mold is analyzed. A clamping mechanism or the like is not modeled and a mold parting face is not taken into consideration. Thus, in the flow analysis system 3, the influence of an insufficient clamping force on a molding phenomenon and part quality cannot be evaluated. Therefore, in order to ensure the accuracy of a molding phenomenon and part quality, it is necessary to conduct an analysis under molding conditions and in a mold structure range such that a clamping force is sufficiently applied.

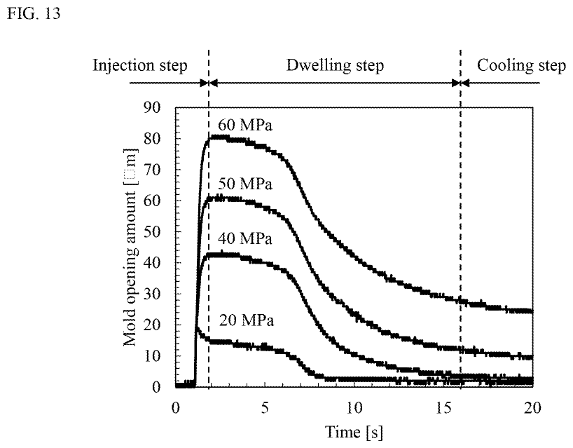

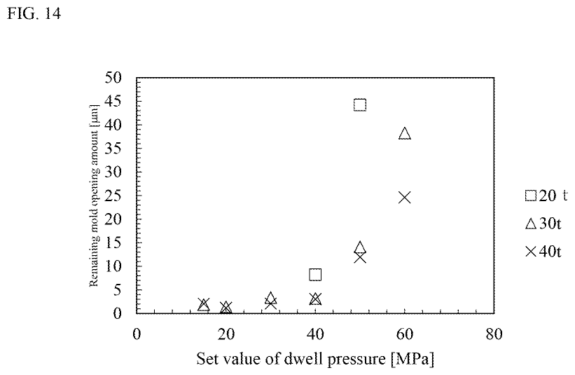

FIGS. 13 and 14 are graphs where an actual clamping force is insufficient even if a calculated necessary clamping force is configured as a molding condition. A mold shape 60 is used for an experiment as illustrated in FIG. 6. As illustrated in FIG. 6, the mold 60 includes a mold position sensor 64 capable of measuring a change of a small mold opening amount with respect to time in an injection molding process. Molding is performed while a clamping force is measured as a parameter.

FIG. 13 shows a measured value of a mold opening amount when a dwell pressure is changed in the range of 20 to 60 MPa with a clamping force of 40 t. As shown in FIG. 13, a mold opening amount peaks in the step of injection and then the mold gradually returns to an original position in the step of dwelling. In the case of a sufficient clamping force, the mold opening amount naturally returns to the original position in the step of cooling.

In FIG. 6, the mold shape 60, or the mold structure 60 has a projection area of about 50 cm² and thus a necessary clamping force calculated by Expression (1) is 30 t at a dwell pressure of 60 MPa. Therefore, a range under the conditions of FIG. 13 does not affect the part quality. However, at a dwell pressure of 50 MPa or more, the mold opening amount does not returns to the original position even in the step of cooling and about 10 to 30 μm is left. In this case, the part quality is affected. For example, a molded article may have a burr or an excessive weight.

FIG. 14 shows a remaining mold opening amount in the step of cooling when a dwell pressure is changed with a clamping force of 20 to 40 t. As shown in FIG. 14, a remaining mold opening amount varies with a clamping force. For example, at a dwell pressure of 40 MPa, the mold opening slightly remains with a clamping force of 20 t. Since the injection molding machines have different machine differences, high quality may not be kept only by configuring the calculated necessary clamping force in the molding conditions. This is because a burr may actually occur due to an insufficient clamping force.

Thus, in the present embodiment, the threshold value of a clamping force (the threshold value of a specific mold opening amount) is experimentally determined in advance for the injection molding machine. When the necessary clamping force exceeds the threshold value, a notification is provided for an operator. This allows the operator to select the molding machine and the molding conditions so as to ensure part quality without the need for actual molding, improving usability. Furthermore, the period of development and the number of trials can be reduced, thereby shortening a lead time for starting volume production. Moreover, a clamping force is determined before a flow analysis is conducted, allowing the operator to configure proper molding conditions without conducting an analysis.

As described above, whether the necessary clamping force is larger than the threshold value may be determined after a flow analysis is conducted (S5). In this case, determination step S33 is performed between step S5 and step S6 that are shown in FIG. 4. Step S33 in step S3A is omitted.

The theoretical value of the necessary clamping force may be calculated from Expression (2) instead of Expression (1).

F=ΣPᵢAᵢ (Expression 2)

The subscript (variable) of the summation sign Σis “i”. “i” denotes the number of segments determined by dividing a total projection area in an analysis model. “Pᵢ” denotes a mean pressure of each segment. “Aᵢ” denotes an area of each segment.

In Expression (1), the necessary clamping force is calculated from a pressure at the inlet of the mold and thus a different value is obtained from the case where a pressure actually applied in the cavity of the mold is used. In Expression (2), a used pressure is obtained from the analysis result and actually applied into the mold, thereby calculating the necessary clamping force with higher accuracy. Thus, a clamping force can be more accurately determined in step S333 shown in FIG. 12. However, Expression (2) requires an analysis for calculating the necessary clamping force. Hence, Expressions (1) and (2) may be used depending on the status of development.

In some cases, a rough determination of a clamping force may be necessary instead of a correct determination of a clamping force by correcting the analysis conditions on the basis of a machine difference of the injection molding machine. In this case, a flow analysis may be conducted after step S3A is omitted, and then a clamping force may be determined. This enables determination of a clamping force only with reference to the molding-machine clamping-force threshold value database 717, eliminating the need for acquiring a correction amount database 716 in advance for molding conditions.

A method of deriving the threshold value of a clamping force specific to the molding machine will be described below. As shown in the example of FIG. 6, the threshold value is derived from the output value of the mold position sensor 64 introduced on the mold parting face of the mold 60. The maximum value of a clamping force in the target injection molding machine is configured as the molding condition.

Injection molding is performed by using, as a parameter, a pressure in the step of injection and dwelling and then a change in mold opening amount with respect to time is recorded. Subsequently, as shown in FIGS. 13 and 14, a remaining mold opening amount is recorded in the step of cooling the mold. A necessary clamping force relative to a set value of a dwell pressure is then calculated on the basis of Expression (1). At this point, the remaining mold opening amount increases and the minimum value of the necessary clamping force of the molding conditions that may affect part quality is recorded in the database 717 as the threshold value of a clamping force specific to the injection molding machine. This can configure a clamping force with more stable part quality than in the related art in consideration of slight mold opening that affects the part quality.

In this case, the necessary clamping force relative to the set value of a dwell pressure can be calculated from Expression (1) by using the set value of a dwell pressure or a pressure applied to the mold by a flow analysis can be predicted and calculated from Expression (2). In molding for acquiring the threshold value of a clamping force, a pressure sensor may be introduced in the mold and the maximum value of a pressure may be actually acquired. Thus, in consideration of a pressure actually applied to the mold, the necessary clamping force can be calculated from Expression (1). This can accurately configure the threshold value of a clamping force specific to the injection molding machine also according to Expression (1).

### Embodiment 3

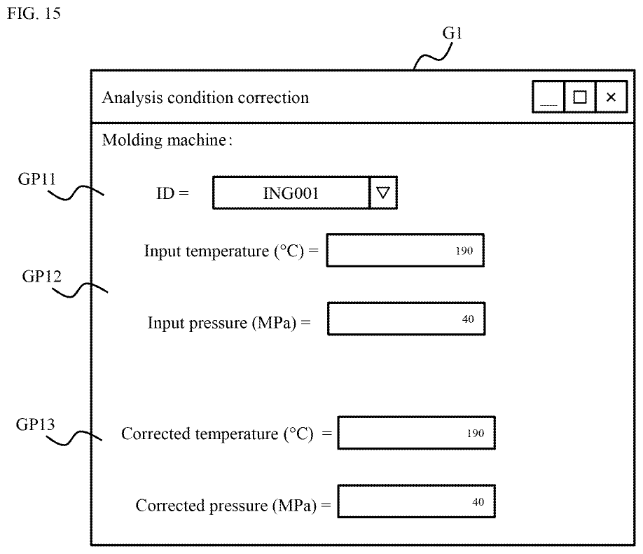

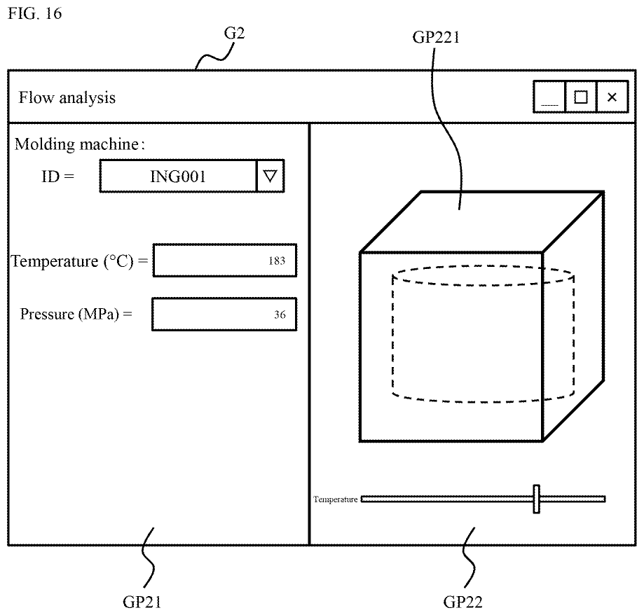

Referring to FIGS. 15 and 16, Embodiment 3 will be described below. The present embodiment will describe an example of a GUI provided for an operator by an injection molding analysis system 1. FIG. 15 illustrates an example of a screen G1 provided for a user in order to correct analysis conditions. FIG. 16 illustrates an example of a screen G2 of flow analysis software that is executed according to the corrected analysis conditions.

The analysis-condition correction screen G1 includes, for example, a molding-machine selection part GP11 for selecting the injection molding machine to be analyzed, a molding-condition configuring part GP12 for configuring molding conditions, and a corrected molding-condition display part GP13 for displaying corrected molding conditions.

The screen G1 indicating two parameters, that is, a pressure and a temperature may include other parameters to be corrected. The screen G1 may further include an execution button for starting correction and a cancel button for cancelling correction.

The flow analysis screen G2 in FIG. 16 includes, for example, an analysis-condition display part GP21 for displaying analysis conditions and a graphics display part GP22 for displaying a state of an injection molding process by three-dimensional graphics GP221 and the like.

The present embodiment configured thus can also achieve the same effects as Embodiments 1 and 2.

### Embodiment 4

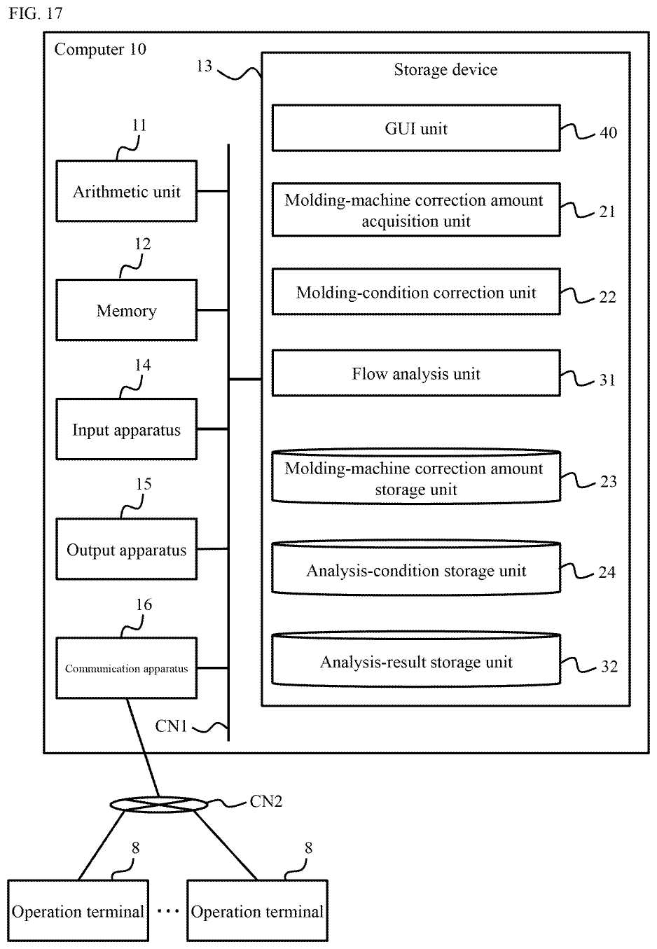

Referring to FIG. 17, Embodiment 4 will be described below. An injection molding analysis system according to the present embodiment is implemented on a computer 10 and is coupled to a plurality of operation terminals 8 via a communication network CN2.

An operator can obtain optimum analysis conditions for each injection molding machine from the computer 10 by operating the operation terminal 8. The operation terminal 8 may be installed for each injection molding machine, a group of injection molding machines, or each factory.

The injection molding analysis system implemented by the computer 10 may be virtually divided for clients and injection-molding analysis service may be provided for each client.

The present embodiment configured thus can provide injection-molding analysis service for a plurality of client companies.

### Embodiment 5

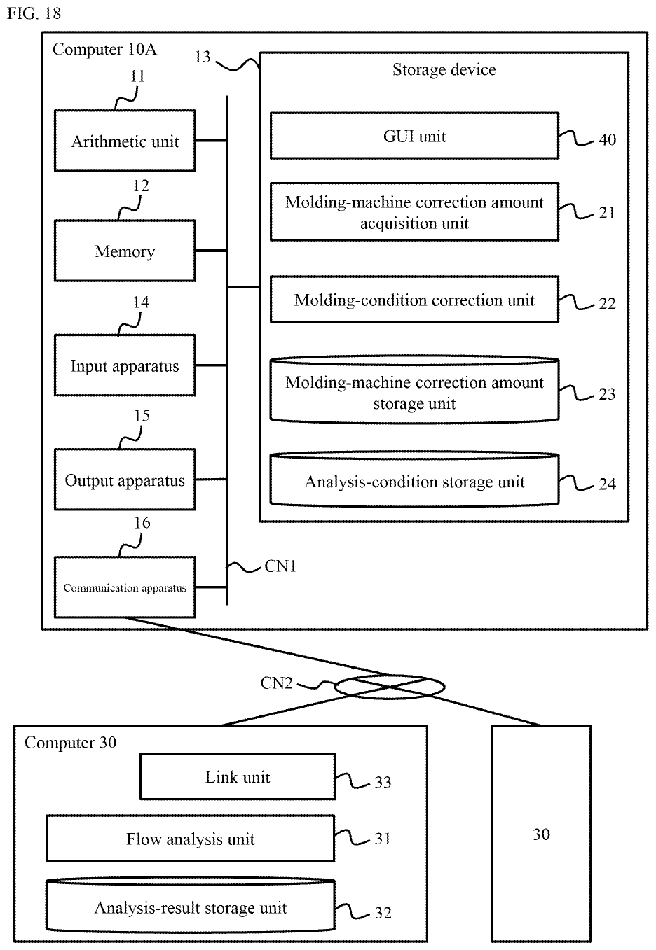

Referring to FIG. 18, Embodiment 5 will be described below. An injection molding analysis system according to the present embodiment is configured such that a computer 10A having the function of correcting molding conditions and a computer 30 for a flow analysis are coupled to each other via a communication network CN2.

The computer 30 for a flow analysis includes a link unit 33 in addition to a flow analysis unit 31 and an analysis-result storage unit 32. The link unit 33 is a function for a link to a molding condition correction system 2 implemented by the computer 10A.

The present embodiment configured thus allows the utilization of an existing flow analysis system, improving convenience.

The present invention is not limited to the foregoing embodiments and includes various modifications. For example, the embodiments were specifically described to illustrate the present invention. All the described configurations are not necessary for the present invention. Moreover, the configuration of one of the embodiments can be partially replaced with the configuration of another embodiment or the configuration of one of the embodiments may further include the configuration of another embodiment. Alternatively, the configurations of the embodiments can partially include additional configurations, can be partially deleted, or can be partially replaced with other configurations.

What is claimed is:

1. An injection molding analysis method of generating an analysis condition of an injection molding machine by using at least one computer,
the at least one computer executing the steps of:
selecting one of injection molding machines, each being associated with a predetermined correction amount of injection molding;
generating a second analysis condition for the selected injection molding machine on the basis of an acquired first analysis condition and the predetermined correction amount of the selected injection molding machine; and
outputting the generated second analysis condition.

2. The injection molding analysis method according to claim 1, wherein
subsequent to the step of outputting the second analysis condition, the at least one computer further executes the step of analyzing, on the basis of the second analysis condition, injection molding performed by the selected injection molding machine.

3. The injection molding analysis method according to claim 1, wherein
the predetermined correction amount is calculated on the basis of a difference between a predetermined physical quantity measured on a predetermined part of the selected injection molding machine and an analytical value for the predetermined physical quantity of the predetermined part of the selected injection molding machine.

4. The injection molding analysis method according to claim 1, wherein
the predetermined correction amount is calculated on the basis of a feature amount of a predetermined physical quantity measured on a predetermined part of the selected injection molding machine and a feature amount of an analytical value for the predetermined physical quantity of the predetermined part of the selected injection molding machine.

5. The injection molding analysis method according to claim 3, wherein
the predetermined part is a part in a mold provided in the selected injection molding machine, and the predetermined part is at least one part configured on a flow path extending from a material flow inlet of the mold to a cavity of the mold.

6. The injection molding analysis method according to claim 3, wherein
the predetermined physical quantity includes at least a pressure and a temperature.

7. The injection molding analysis method according to claim 4, wherein
the feature amount of the predetermined physical quantity includes at least a maximum value of a pressure and a maximum value of a temperature.

8. The injection molding analysis method according to claim 1, wherein
the injection molding machine is also associated with a threshold value of a clamping force of the injection molding machine in addition to the predetermined correction amount,
the computer further executes, subsequent to the step of generating the second analysis condition, the step of calculating a necessary clamping force on the basis of the second analysis condition and comparing the calculated necessary clamping force and the threshold value, and
if it is determined that the necessary clamping force is larger than the threshold value in the step of comparing the necessary clamping force and the threshold value, the determination is outputted.

9. The injection molding analysis method according to claim 2, wherein
the injection molding machine is also associated with a threshold value of a clamping force of the injection molding machine in addition to the predetermined correction amount,
the computer further executes, subsequent to the step of analysis based on the second analysis condition, the step of comparing a necessary clamping force obtained from the analysis based on the second analysis condition and the threshold value, and if it is determined that the necessary clamping force is larger than the threshold value in the step of comparing the necessary clamping force and the threshold value, the determination is outputted.

10. The injection molding analysis method according to claim 8, wherein
the threshold value is configured on the basis of an output value of a mold position sensor that detects a position of a mold parting face.

11. The injection molding analysis method according to claim 8, wherein
the threshold value is configured on the basis of an output value of a mold position sensor that detects a position of a mold parting face and an output value of a pressure sensor that detects a pressure generated in the mold.

12. The injection molding analysis method according to claim 1, wherein
the first analysis condition is an analysis condition inputted to the injection molding machine, and
the second analysis condition is an analysis condition inputted to a flow analysis system that conducts a flow analysis on the injection molding machine.

13. An injection molding analysis system that generates an analysis condition of an injection molding machine, comprising:
a correction amount storage unit that stores a predetermined correction amount of injection molding of each injection molding machine;
a first analysis-condition storage unit that stores an acquired first analysis condition;
a correction amount acquisition unit that acquires, from the correction amount storage unit, the predetermined correction amount corresponding to the selected injection molding machine; and
a correction unit that corrects the first analysis condition to a second analysis condition for the selected injection molding machine on the basis of the first analysis condition acquired from the first analysis condition storage unit and the predetermined correction amount.

14. The injection molding analysis system according to claim 13, wherein
the correction amount storage unit also stores a threshold value of a clamping force of the injection molding machine in addition to the predetermined correction amount, and
the correction unit calculates a necessary clamping force on the basis of the second analysis condition, compares the calculated necessary clamping force and the threshold value, and outputs a determination if it is determined that the necessary clamping force is larger than the threshold value.
